(19) United States
(12) Patent Application Publication
(10) Pub. No.: US 2008/0313851 A1
(43) Pub. Date: Dec. 25, 2008

(54) Slide Rail for a Door Closer or the Like

(75) Inventor: Bernd Winkler, Breckerfeld (DE)

Correspondence Address: COHEN, PONTANI, LIEBERMAN & PAVANE LLP, 551 FIFTH AVENUE, SUITE 1210, NEW YORK, NY, 10176, US

(73) Assignee: Dorma GmbH + Co. KG, Ennejpetal (DE)

(21) Appl. No.: 10/588,435

(22) PCT Filed: Mar. 8, 2005
(86) PCT No.: PCT/EP2005/002402

§ 371 Date: Aug. 4, 2006

(30) Foreign Application Priority Data
Mar. 12, 2004 (DE) 10 2004 012 638.0

(51) Int. Cl. E05F 3/22

(52) U.S. Cl. 16/49

(57) ABSTRACT

A slide channel for a door closer, comprising a guide rail for guiding a slide member connected to the door closer, and a cover element lined with the guide rail.

The invention relates to a slide channel for a door closer or the like comprising a guide rail for guiding a slide member.

Such slide channels are very well known. Generally, their visual aspect is not much appealing and they do only partly adapt to individual customer needs.

Therefore, it is an object of the present invention to create a new slide channel which, from the visual point of view as well, leaves an appealing impression and adapts easily to the individual needs.

This problem is solved with a slide channel for a door closer or the like with a guide rail for guiding a slide member in that the guide rail can be lined with a cover element.

A slide channel is created as a result of this embodiment which, from the visual point of view, has an extraordinary appealing effect and which adapts simply and easily to the individual needs. Even if the cover element is already mounted, it can be exchanged for another one, such that a different taste can be taken into consideration.

Advantageous further developments result from the dependent claims.

According to an advantageous embodiment, the guide rail is open at the end surfaces thereof and each end surface is closed by a fixing part such that the inventive slide channel has an overall closed structural shape.

The impression of a closed structural shape can be even improved if, according to an advantageous further development, the fixing part has an end wall pointing to the outside and the cover element extends as far as the plane of the end wall.

Advantageously, the section of the guide rail is C-shaped to guarantee reliable guiding of the slide member, guided within the guide rail.

Advantageously, the section of the cover element is U-shaped with open end surfaces, such that mounting of the cover element at the guide rail is simple and quick to achieve. It is obvious that a cut is provided within the cover element for the slide member to engage.

For guaranteeing a reliable fixing of the cover element at the guide rail, according to an advantageous further development, the cover element is held at the guide rail via a positive snap connection.

This snap connection is preferably formed in that it is realized by two snap cams protruding to the inside at the free ends of the U-shaped cover element and two snap openings cooperating therewith, formed at the guide rail.

Advantageously, the cover is formed as an extruded profile to achieve sufficient torsion strength.

A particular visual effect can be obtained if, according to a preferred embodiment, a shadow gap, which is visible from the end surface of the slide channel, is formed between the cover element and the end wall.

The shadow gap is preferably realized by means of a notch, provided on three sides of the end wall. There is no notch provided on the fourth side such that, once completely mounted the end wall covers the rear leg of the guide rail without any gap.

According to an advantageous further development, the end wall of the fixing part is formed at a holding block which is provided with an attachment boring for attaching the guide rail to a door, to a door frame, to a wall or the like. Furthermore, the holding block, on the side pointing away from the end wall, presents an extension insertable into the guide rail. On account of this construction, the slide channel can be reliably, easily and quickly mounted to a door, to a door frame or the like.

Furthermore, a particularly appealing visual impression can be obtained, if the slide channel extends over the total width of the door and/or if the door closer, cooperating with the slide channel, presents the same length as the slide channel.

With the inventive slide channel, the slide channel can be attached to the door or the like and the door closer at an associated door frame or the like or the mounting position can be reversed. According to an alternative embodiment, even the door closer can be attached to the door or the like and the slide channel at an associated door frame or the like.

Further details, characteristics and advantages of the invention will result from the following description of a preferred embodiment example, reference being made to the figures, in which:

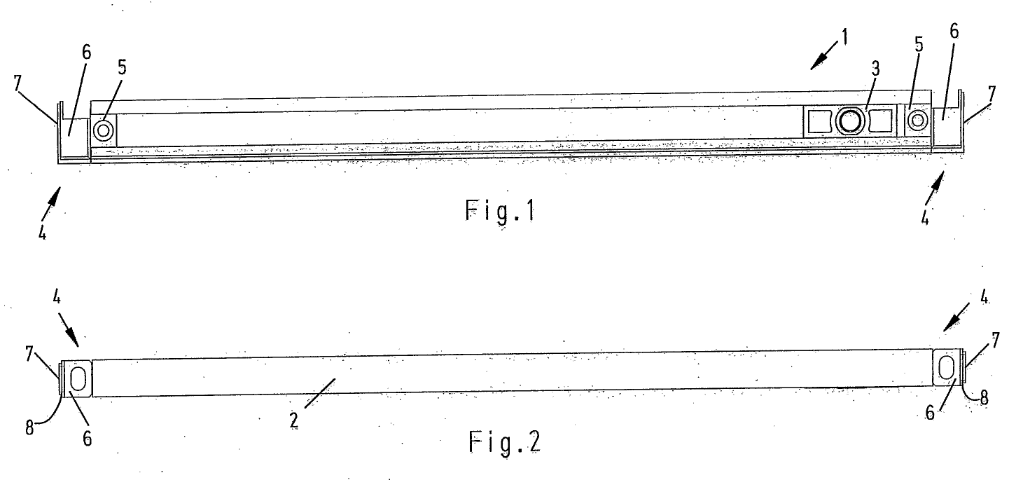

FIG. 1 shows a plane view of the inventively formed slide channel;

FIG. 2 shows a frontal view of the slide channel according to FIG. 1;

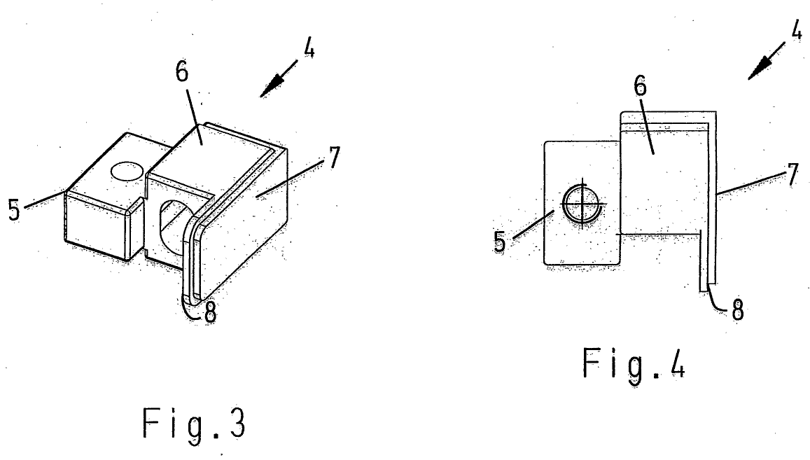

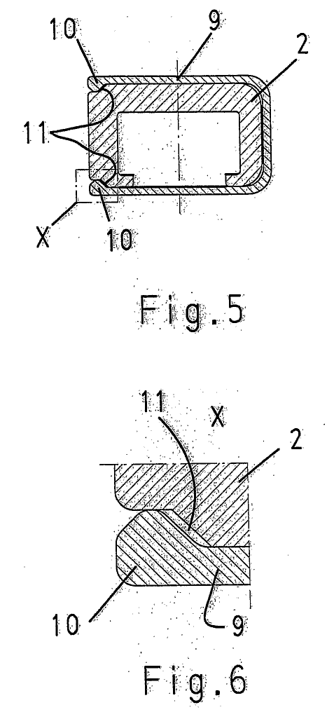

FIG. 3 shows a perspective view of a fixing part;

FIG. 4 shows a plane view of the fixing part of FIG. 3;

FIG. 5 shows a cross-section through the slide channel;

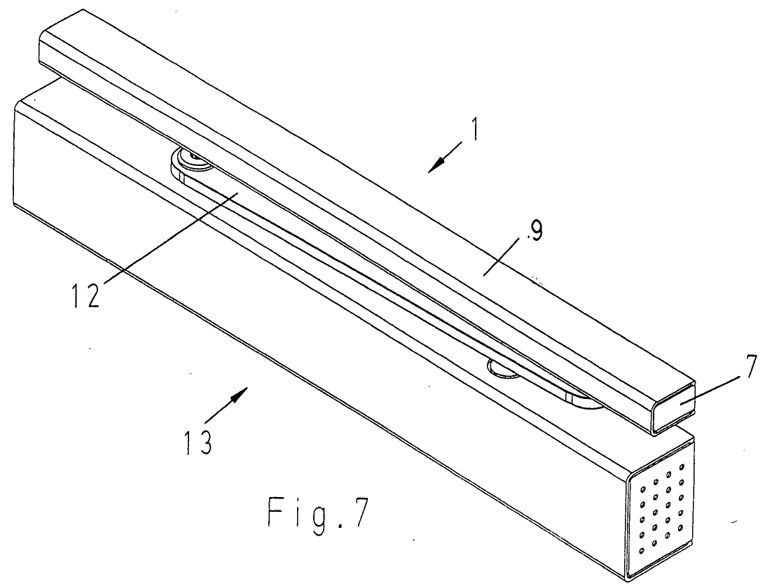

FIG. 6 shows a detailed view of a particular X of FIG. 5;

FIG. 7 shows a perspective view of the inventive slide channel in connection with a door closer; and

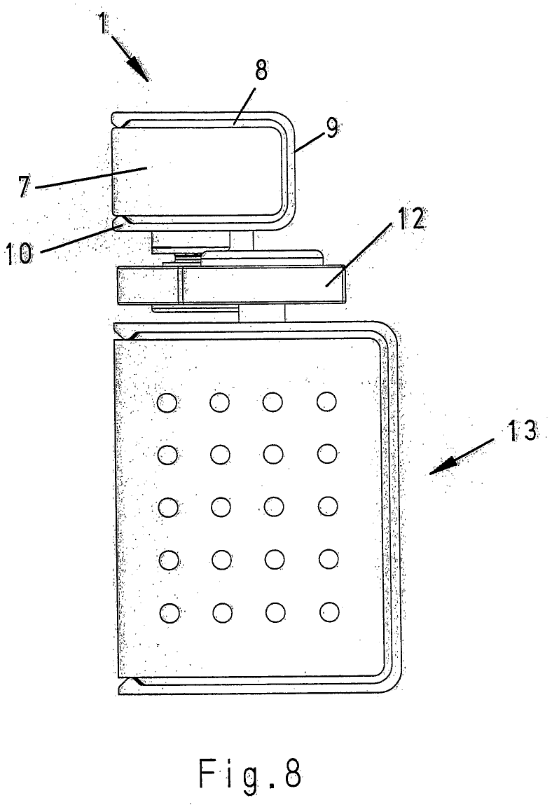

FIG. 8 shows a frontal view of the slide channel and the door closer of FIG. 7.

In this illustration here, only the relevant parts are depicted, all the other structural components have been omitted for better clarity.

A slide channel 1 consists of a C-shaped guide rail 2, in which a slide member 3 is displaceably guided which slide member, with the connecting axis thereof, protrudes from the open side of the guide rail 2 and is connected to a door closer 13 via an arm assembly 12.

Fixing parts 4, provided for attaching the guide rail 2 to a door, to a door frame, to a wall or the like, can be inserted into the open end surfaces of the C-shaped guide rail 2.

Each fixing part 4 consists of an extension 5 insertable into the guide rail 2, of a holding block 6 provided with an attachment boring for the attachment of the guide rail 2, and of an end wall 7. The end wall 7 is provided with a notch for forming a shadow gap 8 on three sides of the circumference thereof.

The guide rail 2 can be lined with a U-shaped cover element 9 which is open at the end surfaces thereof. For attaching the cover element 9 to the guide rail 2, snap cams 10 protruding to the inside are provided in the region of the free ends of the U-shaped cover element 9, which cooperate with snap openings 11 in the guide rail 2.

When mounted, the cover element 9 does not only cover the guide rail 2, but also covers the fixing parts 4 such that, as can be seen particularly in FIG. 7, the fixing parts 4 are not visible in a frontal view, as the open end surfaces of the cover element 9 and the end walls 7 of the fixing parts 4 are located in one plane. As already explained, the notch in the end wall 7 provided on three sides, forms a shadow gap 8 between the end wall 7 and the cover 9. As there is no notch provided on the fourth side of the end wall 7, the fixing parts 4 cover the rear leg of the guide rail 2 on this side, such that the leg can not be seen.

The slide channel 1 can be formed longer than required by the displacement distance of the slide member 3 and therefore extend, for example, over the entire width of the door. For symmetry reasons, the slide channel 1 is formed as long as the door closer 13 cooperating with the slide channel 1.

Depending on the specific application case, the door closer 13 can be attached to the door and the slide channel 1 at the door frame or the like or the slide channel 1 can be mounted to the door and the door closer 13 to the door frame or the like.

By using an additional cover element 9, a particularly individual adaptation to the door closer or also to the fittings employed can be carried out. Thus, the cover element 9 may consist of different materials, particularly of aluminium, stainless steel or plastic material, which, in addition to individual forms, may present different surface treatments.

### REFERENCES

1 slide channel
2 guide rail
3 slide member
4 fixing part
5 extension
6 holding block
7 end wall
8 shadow gap
9 cover element
10 snap cam
11 snap opening
12 arm assembly
13 door closer

1.-17. (canceled)

18. A slide channel for a door closer, comprising:
a guide rail for guiding a slide member connected to the door closer; and
a cover element lining the guide rail.

19. The slide channel of claim 18, wherein the guide rail has two opposite open ends, the slide channel further comprises two fixing parts which close the respective open ends of the guide rail.

20. The slide channel of claim 19, wherein each of the fixing parts has an end wall facing an outside of the slide channel and the end wall being planar in shape, and wherein the cover element extends to the plane of the end wall.

21. The slide channel of claim 18, wherein the guide rail has a generally C-shaped cross section.

22. The slide channel of claim 21, wherein the cover element has two open ends, and a U-shaped cross section with two free ends.

23. The slide channel of claim 22, wherein the cover element is held in place on the guide rail by a positive snap connection.

24. The slide channel of claim 23, wherein the positive snap connection comprises two snap recesses in the guide rail, and two snap cams protruding inward from the respective free ends of the cover element and engaging the respective snap recesses.

25. The slide channel of claim 18, wherein the cover element has an extruded profile.

26. The slide channel of claim 20, having a gap between the cover element and the end wall of each of the fixing parts.

27. The slide channel of claim 26, wherein the end wall has four sides, and a notch on three of the four sides, and wherein the gap is formed by the notch.

28. The slide channel of claim 20, wherein each of the fixing parts has a holding block on which the end wall is formed, the holding block having an attachment boring.

29. The slide channel of claim 28, wherein the holding block has a side facing away from the end wall, and wherein the respective fixing part has an extension extending outward from said side of the holding block and insertable into the guide rail.

30. The slide channel of claim 18, sized to extend over an entire width of a door associated with the door closer.

31. The slide channel of claim 18, further having a length which is equal to a length of the door closer.

32. The slide channel of claim 18, wherein the cover element is comprised of at least one of aluminium, stainless steel and plastic material.
